(19) United States
(12) Patent Application Publication
(10) Pub. No.: US 2026/0230721 A1
(43) Pub. Date: Aug. 6, 2026

(54) IMAGE SENSOR FOR EVENT DETECTION

(71) Applicant: Sony Semiconductor Solutions Corporation, Kanagawa (JP)

(72) Inventors: Raphael BERNER, Stuttgart (DE); Massimo ZANNONI, Stuttgart (DE)

(73) Assignee: Sony Semiconductor Solutions Corporation, Kanagawa (JP)

(21) Appl. No.: 19/149,553

(22) PCT Filed: Jan. 8, 2024
(86) PCT No.: PCT/EP2024/050267

§ 371 Date: Jul. 21, 2025

(30) Foreign Application Priority Data
Feb. 14, 2023 (EP) 23156539.1

(51) Int. Cl. H04N 25/47; H04N 25/771; H04N 25/78

(52) U.S. Cl. CPC H04N 25/47; H04N 25/78; H04N 25/771

(57) ABSTRACT

An image sensor includes a pixel array with pixel circuits, wherein each pixel circuit outputs a request signal REQ in response to a predefined change in illumination. Each pixel circuit includes a floating node configured to temporally store charge as a function of a change of an illumination condition. Each pixel circuit includes a reset switch to set the floating node to a predefined initial potential in response to a reset ramp signal REFR. A ramp signal circuit outputs the reset ramp signal REFR for at least a first group of the pixel circuits.

The present disclosure relates to an image sensor and a solid-state imaging device. More particularly, the present disclosure relates to the field of event detection sensors that respond to changes in light intensity, such as dynamic vision sensors (DVS) and event-based vision sensors (EVS) with continuous, asynchronous detection of events.

### BACKGROUND

Event detection image sensors like DVS and EVS deliver information only about the position of changes in the imaged scene. Unlike image sensors that transfer large amounts of image information in frames, transfer of information about pixels that do not change can be omitted, resulting in a sort of in-pixel data compression. The in-pixel data compression removes data redundancy and facilitates high temporal resolution, low latency, low power consumption, high dynamic range, and little motion blur.

Each DVS or EVS pixel temporarily stores an event indicating an increase or a decrease in detected light intensity compared to a previous readout until the next time the pixel is read out. Each readout of a pixel clears the event.

In image sensors for synchronous event detection, a readout circuit reads out a pixel array row by row.

In image sensors for continuous, asynchronous event detection, each pixel that detects an event indicates the event by outputting a request signal to a readout circuit. In the readout circuit, the request signal triggers the compilation of event information. The event information includes the pixel address identifying the position of the pixel in the pixel array, the sign of the change in light intensity, and a time stamp. The readout circuit passes the event information to an image processor and confirms to the pixel that it has received the event. Upon receiving the confirmation, the pixel deletes the event.

Clearing the event typically includes an automatic zeroing process (“autozero process”, “autozeroing”) that resets a voltage in an input path of a comparator stage to an initial value.

### SUMMARY

For the duration of the autozero process, the pixel is unable to process another event. The autozero process thus defines a dead time for which a previously read pixel is blocked before it can detect the next event. The dead time is sensitive to manufacturing-related deviations between the pixels of a pixel array and is therefore pixel-specific.

The present technology has been made in view of this situation and aims to improve sensing performance of an image sensor for asynchronous event detection.

In this regard, the present disclosure relates to an image sensor having a pixel array that includes pixel circuits. Each pixel circuit is configured to output a request signal in response to a predefined change in illumination. Each pixel circuit includes a floating node configured to temporally store charge as a function of a change of an illumination condition, and a reset switch configured to set a potential of the floating node to a predefined initial potential in response to a reset ramp signal. The image sensor further includes a ramp signal circuit configured to output the reset ramp signal for at least a first group of the pixel circuits. The first group includes more than one pixel circuit.

The ramp signal circuit is shared by at least one group of pixel circuits and may be formed in a peripheral portion of the image sensor and/or in a signal processing layer. The ramp signal circuit(s) can be realized outside the pixel array, and thus with fewer area constraints. Dead time deviations between pixel circuits receiving the reset ramp signals from multiple ramp signal circuits are smaller than for the case where each pixel circuit contains an own ramp signal circuit.

For asynchronous image sensors with separate ramp signal circuits in each pixel circuit, the dead time is usually extended to such an extent that the effects of manufacturing-related deviations between individual pixels are reduced with respect to the response to the autozero process. The dead time can be up to hundreds of microseconds, and each pixel circuit requires a bias source and an appropriately sized capacitor to generate the reset ramp signal. In this respect, the asynchronous image sensor with shared ramp signal circuit according to the present embodiments allows for shorter dead times and shows smaller dead time variations. Time resolution can be increased and thus the sensing performance improved.

The described embodiments, together with further advantages, will be best understood by reference to the following detailed description taken in conjunction with the accompanying drawings.

### BRIEF DESCRIPTION OF THE DRAWINGS

FIG. 1 is a schematic diagram illustrating a configuration example of an imaging apparatus as an electronic device including a solid-state imaging device with an image sensor according to an embodiment.

FIG. 2 is a simplified block diagram illustrating a configuration example of a solid-state imaging device with an image sensor for non-continuous, asynchronous readout and shared reset ramp signal in accordance with an embodiment.

FIG. 3 is a schematic diagram illustrating an embodiment in which the sold-state imaging device has a two-layer structure in a stacked CIS configuration.

FIG. 4 is a simplified block diagram illustrating a configuration example of a group of pixels sharing the same reset ramp signal in accordance with an embodiment.

FIG. 5 is a simplified block diagram illustrating a configuration example of a pixel circuit in accordance with an embodiment.

FIG. 6 is a simplified block diagram illustrating a configuration example of an image sensor in accordance with an embodiment related to a global reset ramp signal.

FIG. 7 is a time diagram for illustrating a method of operating an image sensor using a global reset ramp signal in accordance with an embodiment.

FIG. 8 is a simplified block diagram illustrating a configuration example of pixel circuit according to an embodiment related to a global reset ramp signal.

FIG. 9 is a simplified block diagram illustrating a configuration example of a pixel circuit in accordance with an embodiment with latches generating pixel internal control signals to process a global reset ramp signal.

FIG. 10 is a state diagram for illustrating a method of operating an image sensor using a global reset ramp signal in accordance with an embodiment.

FIG. 11 is a simplified block diagram illustrating a configuration example of an image sensor in accordance with an embodiment using row reset ramp signals.

FIG. 12 is a simplified block diagram illustrating a configuration example of pixel circuit according to an embodiment related to row reset ramp signals.

FIG. 13 is a simplified block diagram illustrating a configuration example of a pixel circuit in accordance with an embodiment using reset latch signals to process row reset ramp signals.

FIG. 14 is a time diagram for illustrating a method of operating an image sensor using row reset ramp signals.

FIG. 15 is a state diagram for illustrating a method of operating an image sensor using row reset ramp signals in accordance with an embodiment.

FIG. 16 is a circuit diagram of a radiation sensitive circuit of a pixel circuit of an image sensor in accordance with the embodiments.

FIG. 17 is a circuit diagram of a capacitive amplifier circuit and a pixel comparator circuit of a pixel circuit of an image sensor in accordance with the embodiments.

FIG. 18 is a circuit diagram of an autozero enable switch of a pixel circuit of an image sensor in accordance with the embodiments.

FIG. 19 is a simplified block diagram illustrating a row arbiter interface in accordance with embodiments related to row reset ramp signals.

FIG. 20 is a time diagram for illustrating a method of operating the row arbiter interface of FIG. 19 in accordance with an embodiment.

FIG. 21 is a state diagram for illustrating a method of operating the row arbiter interface of FIG. 19 in accordance with an embodiment.

FIG. 22 is a block diagram depicting an example of a schematic configuration of a vehicle control system.

FIG. 23 is a diagram of assistance in explaining an example of installation positions of an outside-vehicle information detecting section and an imaging section of the vehicle control system of FIG. 22.

### DETAILED DESCRIPTION

Embodiments for implementing techniques of the present disclosure will be described below in detail using the drawings. The techniques of the present disclosure are not limited to the described embodiments, and various numerical values and the like in the embodiments are illustrative only. The same elements and elements with the same functions are denoted by the same reference signs. Duplicate descriptions are omitted.

Connected electronic elements may be electrically connected through a direct and permanent low-resistive connection, e.g., through a conductive line. The terms “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g., MOSFETs, transmission gates, and others.

The load path of a transistor is the controlled path of a transistor. For example, a voltage applied to the gate of a field effect transistor (FET) controls the current flow through the load path between source and drain of the FET by field effect.

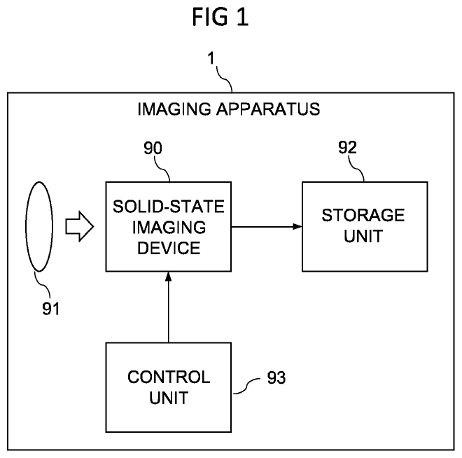

In FIG. 1, an imaging apparatus 1 includes an optical system 91, a solid-state imaging device 90, a storage unit 92, and a control unit 93. The optical system 91 includes one or more lenses and various mechanisms such as an autofocus mechanism and a diaphragm mechanism, and guides light from an object to a light receiving surface of the solid-state imaging device 90.

The solid-state imaging device 90 includes an image sensor having a plurality of pixel circuits. Each pixel circuit includes a radiation sensitive element that converts incident radiation into electric signals by photoelectric conversion, and outputs the electric signals. The solid-state imaging device 90 further includes a signal processing unit that performs predetermined signal processing on the electric signals output from the pixel circuits and outputs image data based on the electric signals.

The storage unit 92 stores the image data output from the solid-state imaging device 90 in a storage medium. The storage medium may include a volatile storage medium and/or non-volatile storage medium. The non-volatile storage medium may be or include a flash memory or a hard disk drive. The non-volatile storage medium may be or include a dynamic random access memory (DRAM).

The control unit 93 controls the solid-state imaging device 90, such that the solid-state imaging device 90 performs an imaging operation. The imaging operation includes capturing an image of an object or a scene and outputting image data including image information about the object or the scene.

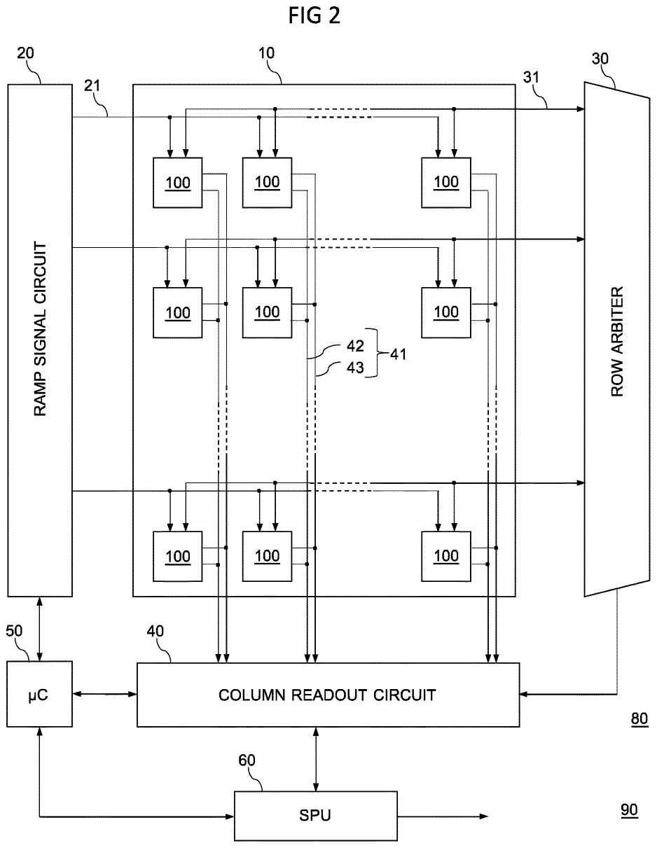

FIG. 2 is a block diagram illustrating a configuration of an example of a solid-state imaging device 90 with an image sensor 80 applicable to the embodiments. The solid-state imaging device 90 includes the image sensor 80 and a signal processing unit 60. The image sensor 80 includes a pixel array 10, a ramp signal circuit 20, a row arbiter 30, a column readout circuit 40, and a sensor control circuit 50.

In the pixel array 10, a plurality of pixel circuits 100 is arrayed in a two-dimensional matrix in pixel rows and pixel columns. For simplicity, pixel circuits 100 belonging to the same pixel row are arranged along a horizontal line in FIG. 2, and pixel circuits 100 belonging to the same pixel column are arranged along a vertical line in FIG. 2.

Each pixel circuit 100 includes a radiation sensitive circuit, an event detection circuit, and a pixel logic circuit. The radiation sensitive circuit outputs a voltage corresponding to the intensity of received radiation. The event detection circuit detects an event based on the magnitude of changes in the voltage received from the radiation sensitive circuit. The event detection circuit is resettable to an initial state by temporarily turning on a reset switch. The pixel logic circuit controls the output of event data from the pixel circuit 100 and the autozeroing of the event detection circuit.

The event data may indicate that the intensity of received radiation has decreased by more than a certain value compared to the previous event readout (“OFF event”). Alternatively, the event data may indicate that the intensity of received radiation has risen by more than a certain magnitude compared to the magnitude at the previous event readout (“ON event”). The event data is transmitted on an event data bus 41.

Control buses 31 connect the pixel circuits 100 with the row arbiter 30. Each control bus 31 connects the pixel circuits 100 of one group with the row arbiter 30. Each control bus 31 may include a request line for transmitting request signals from the pixel circuits 100 of the pixel group to the row arbiter 30. The control bus 31 may include an acknowledgement line for transmitting a group select signal from the row arbiter 30 to the pixel circuits 100 of the pixel group.

For each pixel circuit 100 detecting an event, the pixel logic circuit of the concerned pixel circuit 100 outputs a request to the row arbiter 30 through the control bus 31. For transmitting the request, a request signal transmitted on the request signal line has an active level.

The row arbiter 30 performs arbitration according to the pending active requests output from the pixel circuits 100 of the pixel array 10. The row arbiter 30 selects a request received from a specific pixel group and confirms the request by outputting a confirmation on the control bus 31 and transmits the corresponding row address to the column readout circuit 40. For transmitting the confirmation, a group select signal transmitted on an acknowledgement signal line has an active level.

In response to the confirmation, all pixel circuits 100 in which an event has been detected, apply the event data on the respective event data bus 41. Each event data bus may be connected to some or all pixel circuits 100 of a same pixel column, or to all pixel circuits 100 of more than one pixel column.

The event data bus 41 may include a shared data line for transmitting the ON events and the OFF events by different signal levels or in a time multiplex scheme. In the illustrated embodiment, the event data bus 41 includes a first data line 42 for transmitting the ON events and a second data line 43 for transmitting the OFF events. For transmitting an ON event, an ON event signal transmitted on the first data line 42 has an active level. For transmitting an OFF event, an OFF event signal transmitted on the second data line 43 has an active level.

The column readout circuit 40 receives the event data from all pixel circuits 100 of the selected pixel group via the event data bus 41, and the row address(es) of the selected pixel group from which the received event data originates. From the row address and identifiers of the event data buses 41 transmitting event data, the column readout circuit 40 compiles a digital address event representation AER for each event. The AER includes the row address, a column address derived from the identifiers of the event data busses transmitting events, the event data, and, if applicable, a time stamp. The column readout circuit 40 outputs the AERs to the signal processing unit 60.

The ramp signal circuit 20 outputs at least one reset ramp signal REFR and transmits the reset ramp signal REFR via a ramp control bus to a group of pixel circuits 100, e.g., to some or all pixel circuits 100 of a pixel row or to the pixel circuits 100 of more than one pixel row. For each pixel circuit 100, the pixel logic circuit controls a reset of the event detection circuit by letting pass the reset ramp signal REFR to a gate of the reset switch only when predefined conditions are fulfilled. The ramp control bus 21 includes at least a ramp signal line for transmitting the reset ramp signal. The ramp control bus 21 may include further lines for transmitting further control signals from the ramp signal circuit 20 to the pixel circuits 100.

The sensor control circuit 50 may control a timing of the ramp signal circuit 20 and/or a communication between the column readout circuit 40 and the signal processing unit 60.

The signal processing unit 60 receives the AERs. The signal processing unit 60 may execute signal processing such as image recognition processing based on the received AERs. The signal processing unit 60 may output processed image data, e.g., to the storage unit 92 of FIG. 1 and/or through a wired or wireless electronic interface.

By providing the reset ramp signal REFR from a single source outside the pixel array 10 to a plurality of pixel circuits 100 electrically connected for outputting requests, the image sensor 80 provides an asynchronous readout which can be operated with comparatively short dead times.

The solid-state imaging device 90 a described with reference to FIG. 2 can be provided as, for example, a stacked contact image sensor (CIS) formed by stacking a plurality of semiconductor chips. As an example, the solid-state imaging device 90 a can be formed by a two-layer structure in which semiconductor chips are stacked in two layers.

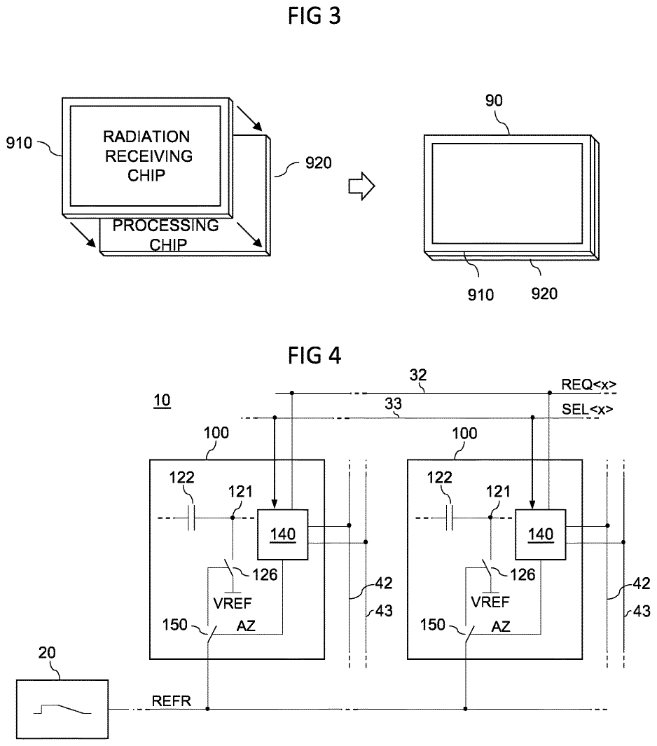

FIG. 3 is a diagram illustrating an example in which the solid-state imaging device 90 of FIG. 2 is formed by a stacked CIS having a two-layer structure with a radiation receiving chip 910 and a processing chip 920. The radiation receiving chip 910 includes at least the radiation sensitive elements, e.g., the complete radiation sensitive circuit, or the complete radiation sensitive circuit and further elements of the pixel circuits. The processing chip 920 includes the further elements of the pixel circuits 100, e.g., the event detection circuit and the pixel logic circuit. As illustrated on a right side of FIG. 3, the solid-state imaging device 90 is formed as one sensor by bonding the first-layer semiconductor chip and the second-layer semiconductor chip while electrically bringing contact pads on the radiation receiving chip 910 in contact with corresponding contact pads on the processing chip 920.

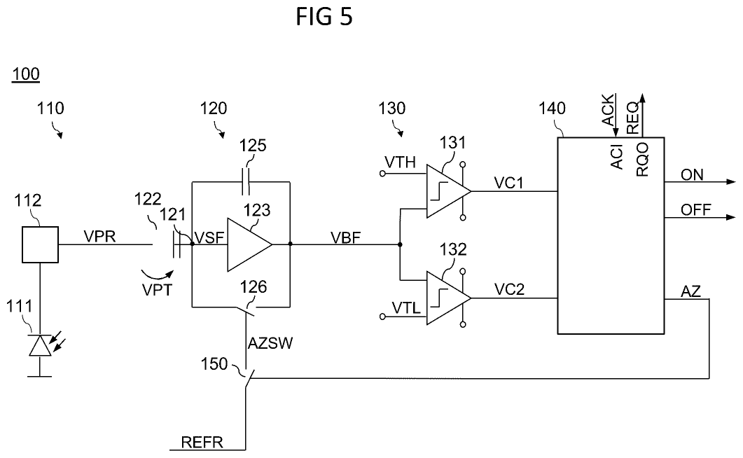

FIG. 4 shows an image sensor that includes a pixel array 10 and a ramp signal circuit 20. The pixel array 10 includes pixel circuits 100. Each pixel circuit 100 outputs a request signal REQ in response to a predefined change in illumination. Each pixel circuit 100 includes a floating node 121 configured to temporally store charge as a function of a change of an illumination condition, and a reset switch 126 configured to set the floating node 121 to a predefined initial potential in response to a reset ramp signal REFR. The ramp signal circuit 20 outputs the reset ramp signal REFR for at least a first group of the pixel circuits 100.

The pixel circuits 100 output the request signal REQ on request signal lines 32. A resulting voltage of the floating node 121 is a function of a change in illumination intensity. The change in illumination is the difference in light intensity between a current time and a previous time.

The amount of charge stored on the floating node 121 corresponds to a change in brightness detected by the pixel circuit 100 between the currently detected brightness and a brightness evaluated at a previous point in time, e.g., at a preceding readout of the pixel circuit 100. The predefined change in brightness corresponds to a predefined amount of charge stored on the floating node 121 and to a predefined voltage between the floating node 121 and a reference potential VSS. The reset switch 126 switches the floating node 121 to the predefined initial potential during an autozero period. For example, the reset switch 126 may temporarily connect the floating node 121 to a predefined potential, e.g., to the reference potential VSS of the pixel array 10 or may temporarily short-circuit a feedback element of an amplifier circuit whose input is connected to the floating node 121.

The process of initializing the potential at the floating node 121 will be referred to as autozero process in the following for ease of reading. The autozero process includes a partial or complete discharge of the floating node 121. When the potential at the floating node 121 has reached the initial potential, the recess switch 126 turns off. Turning off the recess switch 126 too fast may cause significant charge injection into the floating node 121.

Applying a comparatively slowly changing reset ramp signal to the gate of the recess switch 126 to turn off the recess switch 126 avoids turning off the recess switch 126 too fast and mitigates resulting issues. If the recess switch 126 is an n channel FET controlled by a reset ramp signal REFR changing between an inactive low level and an active high level, the recess switch 126 turns on with a leading edge in the recess ramp signal REFR and turns off with the trailing edge in the recess ramp signal REFR. The trailing edge of the reset ramp signal REFR is significantly shallower (less steep) and falls or rises at a significantly lower rate, e.g., by at least one order of magnitude slower than other signals controlling the pixel circuit 100 or output by the pixel circuit 100. For example, the trailing edge of the reset ramp signal REFR can be significantly shallower and can fall or rise at a significantly lower rate, e.g., by at least one order of magnitude slower than the leading edge of the reset ramp signal REFR rises. For example, the trailing edge of the reset ramp signal REFR might take a few microseconds, corresponding to a slope in the range of 0.1V/μs to 1V/μs. The leading edge of the reset ramp signal REFR and/or other control signals typically take 100 ns or less for a transition. The slope of the trailing edge may be fixed. Alternatively, the slope may be programmable. For example, the ramp signal circuit 20 includes a register whose output(s) affect the slope of the ramp, wherein the register can be set by the sensor control circuit 50 of FIG. 2 and/or by the control unit 93 of FIG. 1. The control unit 93 and/or the sensor control circuit 50 may change the register setting in response to a change in user setting, sensor internal conditions and/or illumination conditions.

The ramp signal circuit 20 generates the reset ramp signal REFR with the shallow trailing edge and applies the reset ramp signal REFR to the pixel array 10. An output of the ramp signal circuit 20 is electrically connected to each of the pixel circuits 100 of a first group of pixel circuits 100 in the pixel array 10. The first group of pixel circuits 100 may include some or all pixel circuits 100 of one pixel row, some or all pixel circuits 100 of a plurality of neighboring pixel rows, some or all pixel circuits 100 of a plurality of not neighboring pixel rows, or all pixel circuits 100 of the pixel array 10.

Between the pixel circuits 100 of the same group no mismatches occur with respect to the length of the autozero period. Otherwise, such mismatch must be accounted for by a suitable safety margin for the length of the autozero period to ensure that each pixel circuit 100 is properly reset after each event. With the embodiments, such a safety margin becomes obsolete or can be significantly reduced. A dead time during which the pixel circuit does not detect illumination changes can be reduced accordingly.

The pixel circuits 100 may be configured such that for each pixel circuit 100, the reset ramp signal REFR is passed to the reset switch 126 only for a period of time after detection of a predefined change in illumination in the pixel circuit 100 and before and end of setting the initial potential at the floating node 121, e.g., from a detection of a predefined change in illumination until an end of setting the initial potential at the floating node 121.

A pixel circuit 100 is only reset under the condition that the pixel circuit 100 has detected and output an event since the last readout. For example, the reset switch 126 may be or include an FET. An analog switch may pass the reset ramp signal REFR to a gate of the reset switch 126 only for the period of time from the detection of a predefined change in illumination to the setting of the initial potential at the floating node 121.

More particularly, each pixel circuit 100 may include an autozero enable switch 150 for temporarily disconnecting the gate of the reset switch 126 from the reset ramp signal REFR. An autozero signal AZ controls the autozero enable switch 150. The autozero signal AZ may be a binary signal changing between an active level and an inactive level. The active level turns on the autozero enable switch 150. The inactive level turns off the autozero enable switch 150. The autozero signal AZ may image an internal state of the pixel circuit 100 and allows a conditional autozero process.

The autozero signal AZ may be active and the autozero enable switch 150 may be on during a period from the output of an event by the pixel circuit 100 to the end of the autozero period. During the rest of the time, the autozero signal AZ can be inactive and the autozero enable switch 150 can be off.

FIG. 5 shows a block diagram of a pixel circuit 100 for an asynchronous image sensor 80 as illustrated in FIG. 2.

A radiation sensitive circuit 110 outputs a pixel voltage signal VPR proportional to incoming light intensity. An event detection circuit includes a capacitive amplifier circuit 120 and a pixel comparator circuit 130. The capacitive amplifier circuit 120 generates an amplified voltage signal VBF. The pixel comparator circuit 130 compares the amplified voltage signal VBF with an upper reference voltage VTH and a lower reference voltage VTL. A pixel logic circuit 140 outputs pixel event signals ON, OFF based on a result of comparisons of the amplified voltage signal VBF with the upper reference voltage VTH and the lower reference voltage VTL.

The radiation sensitive circuit 110 includes a photoelectric conversion element 111 and outputs the pixel voltage signal VPR. A voltage level of the pixel voltage signal VPR depends on a photodetector current generated by the photoelectric conversion element 111.

More particularly, the radiation sensitive circuit 110 includes the photoelectric conversion element 111 and a photoreceptor circuit 112. The photoelectric conversion element 111 may include or consist of a photodiode which by means of the photoelectric effect converts electromagnetic radiation incident on a detection surface into a photodetector current. The electromagnetic radiation may include visible light, infrared radiation and/or ultraviolet radiation. The amplitude of the photodetector current corresponds to the intensity of the incident electromagnetic radiation, wherein in the intensity range of interest the detector current increases approximately linearly with increasing intensity of the detected electromagnetic radiation.

The photoreceptor circuit 112 converts the photodetector current into the pixel voltage signal VPR. The voltage of the pixel voltage signal VPR is a function of the photodetector current, wherein in the voltage range of interest the voltage amplitude of the current photoreceptor signal VPR increases with increasing photodetector current. For example, the voltage of the pixel voltage signal VPR increases with the photodetector current logarithmically.

By subtracting a previously evaluated photoreceptor voltage VPT from the current pixel voltage signal VPR, the capacitive amplifier circuit 120 obtains a floating voltage VSF. The amplified voltage signal VBF represents an amplified difference between the previously evaluated photoreceptor voltage VPT and the present voltage of the pixel voltage signal VPR.

The pixel comparator circuit 130 receives the amplified voltage signal VBF from the capacitive amplifier circuit 120 and compares the amplified voltage signal VBF with the upper reference voltage VTH and the lower reference voltage VTL.

In the illustrated embodiment, the pixel comparator circuit 130 includes two comparators 131, 132 for simultaneously comparing the output signal of the amplifier circuit 123 with the upper voltage threshold VTH and the lower voltage threshold VTL.

The first comparator 131 outputs a first comparator output signal VC1 changing between an active level and an inactive level. The first comparator 131 outputs an active level (active first comparator output signal) only when the output signal of the capacitive amplifier circuit 120 exceeds the upper voltage threshold VTH. The second comparator 132 outputs a binary second comparator output signal VC2 changing between an active level and an inactive level. The second comparator 132 outputs an active level (active first comparator output signal) only when the output signal of the capacitive amplifier circuit 120 falls below the lower voltage threshold VTL.

According to another example, the pixel comparator circuit 130 includes a three-level comparator that outputs a combined comparator output signal changing between two different active levels and an inactive level. The three-level comparator outputs a first active level when the amplified voltage signal VBF received from the capacitive amplifier circuit 120 exceeds the upper voltage threshold VTH, a second active level when the output signal of the capacitive amplifier circuit 120 falls below the lower voltage threshold VTL, and the inactive level otherwise.

According to another example, the pixel comparator circuit 130 includes one single comparator successively comparing the amplified voltage signal VBF with the upper voltage threshold VTH and the lower voltage threshold VTL. The single comparator outputs an active level in a first phase, when the amplified voltage signal VBF exceeds the upper voltage threshold VTH, an active level in a subsequent second phase, when the amplified voltage signal VBF falls below the lower voltage threshold VTL, and the inactive level otherwise.

The pixel logic circuit 140 receives the comparator output signals from the pixel comparator circuit 130 and control signals from outside the pixel array 10. Based on the comparator output signals, the pixel logic circuit 140 generates and outputs a request signal REQ for registering an event read out through the row arbiter 30 of FIG. 2. The pixel logic circuit 140 outputs the request signal REQ through a request signal output RQO to a request signal line. The request signal output RQO may be an open collector output or any other output type allowing a plurality of pixel circuits 100 to be connected to the same request signal line.

The pixel logic circuit 140 generates event data signals EVP, EVN on the basis of the comparator output signals and transmits the event data signals EVP, EVN in response to an active acknowledgement signal ACK received through an acknowledgement input ACI to the column readout circuit of FIG. 2. Further on the basis of the comparator output signals, the pixel logic circuit 140 generates an active signal AZ and outputs an active autozero signal to the autozero enable switch 150 in response to a received acknowledgement signal ACK, provided that the pixel circuit 100 has detected an event since the last read out. The active autozero signal turns on the autozero enable switch 150 for the autozero period such that the voltage at the floating node 121 can be reset to the initial voltage with the next active ramp signal.

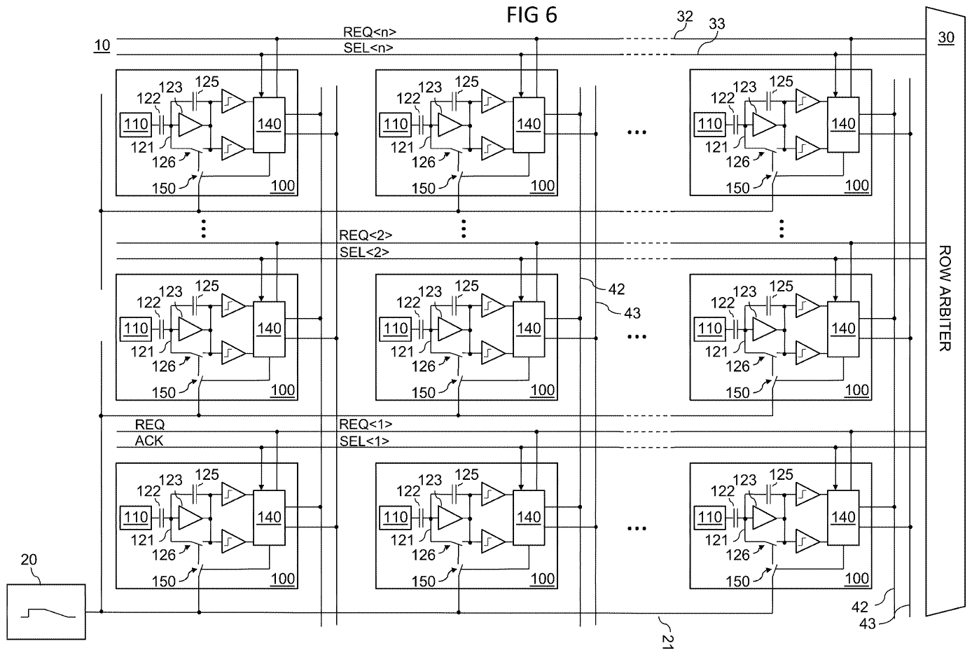

FIG. 6 shows an embodiment with an image sensor 80 using a global reset ramp signal REFR.

The row arbiter 30 outputs a group select signal SEL<x> to a first group of the pixel circuits 100 in response to a group request signal REQ <x> received from any of the pixel circuits 100 of the first group.

Each group of pixel circuits 100 may include some or all pixel circuits 100 of one pixel row, or some or all pixel circuits 100 of more than one pixel row. In the illustrated embodiment, each pixel group includes all pixel circuits 100 of the same pixel row.

In response to the group select signal SEL<x>, each pixel circuit 100 of the selected group of pixel circuits 100 having detected an event outputs event data and initiates autozeroing.

The ramp signal circuit 20 is configured to output the reset ramp signal REFR for each pixel circuit 100 of the pixel array 10.

The ramp signal circuit 20 outputs a single reset ramp signal REFR. Each pixel circuit 100 receives the same reset ramp signal REFR or a signal derived from the same reset ramp signal REFR. The ramp signal circuit 20 may include buffers (not illustrated) to distribute the reset ramp signal REFR across the pixel array 10. For example, the ramp signal circuit 20 may include a buffer circuit for each n pixel rows, e.g., one row buffer circuit for each single pixel row. All row buffer circuits receive the same original reset ramp signal and each pixel circuit 100 of a pixel row receives a buffered reset ramp signal from the row buffer circuit.

The ramp signal circuit 20 transmits the same reset ramp signal REFR to all pixel circuits 100 of the pixel array 10 so that no mismatch occurs between the pixel circuits of the pixel array 10 with respect to the length of the autozero period.

The ramp signal circuit 20 may be configured to output the reset ramp signal REFR at regular time intervals.

The reset ramp signal REFR is a periodic signal. The regular time intervals have the same length. The ramp signal circuit 20 may operate asynchronous with respect to control signals output by the pixel array 10 and the row arbiter 30. Alternatively, the ramp signal circuit 20 and the row arbiter 30 may share a common clock signal or a common source for a clock signal for control signals transmitted on the control buses 31 to the pixel circuits 100.

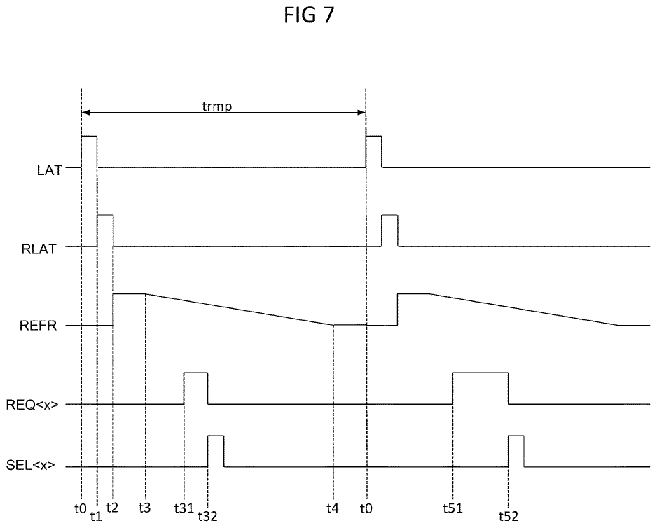

FIG. 7 shows two periods of a global reset ramp signal REFR. One period of the reset ramp signal REFR defines an autozero interval with an interval length trmp. Each pixel circuit 100 applies the reset ramp signal REFR to the gate of reset switch 126 of FIG. 6. Within each autozero interval, the reset ramp signal REFR changes once between a low level and a high level and once between the high level and the low level. The leading edge turns on the reset switch 126 of FIG. 6 and may be comparatively steep. The reset ramp signal REFR may maintain the reached level for some time. The trailing edge is typically less steep than the leading edge and turns off the reset switch 126 of FIG. 6.

In the illustrated embodiment, the reset switch 126 of FIG. 6 is an NFET (n channel field effect transistor). The leading edge of the reset ramp signal REFR is a rising edge, and the trailing edge is a falling edge. If the reset switch 126 of FIG. 6 is a PFET (p channel field effect transistor), the leading edge of the reset ramp signal REFR can be a falling edge, and the trailing edge a rising edge. The reset ramp signal REFR reaches the low level and remains at the low level for the rest of the autozero interval. The trailing edge changes at a significantly lower rate, e.g., by at least one order of magnitude slower than other signals controlling the pixel circuit 100 or output by the pixel circuit 100. For example, the trailing edge of the reset ramp signal REFR can be significantly shallower and can change at a significantly lower rate, e.g., by at least one order of magnitude slower than the leading edge.

Within each pixel row x, the first pixel circuit 100 detecting an event sets the row request signal REQ<x> on a request signal line 32 to an active level. The active level is the low level if the request signal line 32 is terminated with a pull-up construction. In FIG. 7, the high level represents the active level for better legibility.

The row arbiter 30 of FIG. 6 selects one of the pixel rows with active request for readout and triggers the readout of the selected pixel row by setting a group select signal SEL<x> to an active level. In this case, the group select signal SEL<x> is a row select signal. The acknowledgement signal is transmitted on an acknowledgement signal line 33 for each pixel row. In the illustrated embodiment, the active level is the high level. The signals on the request signal line 32 and the acknowledgement signal line 33 are asynchronous with respect to the reset ramp signal REFR. All pixel circuits 100 of the selected pixel row that have detected an event are read out synchronously.

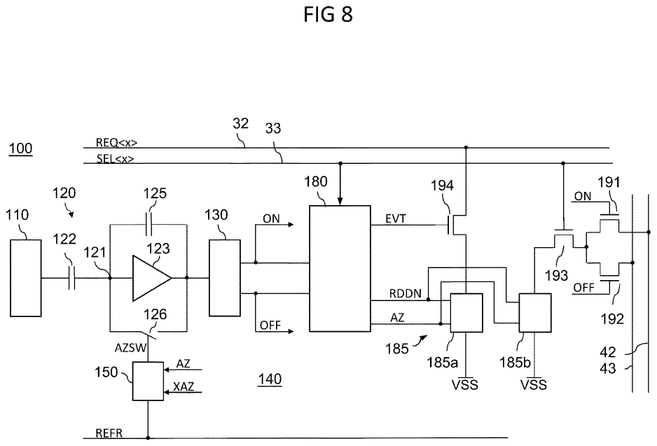

FIG. 8 shows details of a configuration example of a pixel circuit 100 for an image sensor using a global reset ramp signal REFR. The pixel circuit 100 includes a radiation sensitive circuit 110, a capacitive amplifier circuit 120 and a pixel comparator circuit 130 outputting pixel event signals ON, OFF as described with reference to FIG. 5.

Each of the pixel circuits 100 includes a reset latch circuit 180 configured to suppress an output of the request signal REQ for a period starting after information about the predefined change in illumination has been read out until an end of a following complete period of the reset ramp signal REFR.

The reset latch circuit 180 is part of the pixel logic circuit 140 as described with reference to FIG. 4 and FIG. 5. A period of the reset ramp signal REFR includes a transition from the inactive level to the active level and a following transition from the active level to the inactive level. The following complete period may be the next complete period when only a low number of pixel rows detects events per autozero interval. The following complete period may be another period when a high number of pixel rows detects events per autozero interval.

That is, after detecting an event, the pixel circuit 100 requests a readout. Upon receiving a confirmation from the row arbiter, the pixel circuit 100 outputs the ON signal or the OFF signal on the event data bus 41 and then waits until the reset of the floating node 121 to the initial potential has been completed. To this purpose, the pixel circuit 100 applies the reset ramp signal REFR to the gate of the reset switch 126 for the next complete period of the reset ramp signal REFR or for another following period of the reset ramp signal REFR. The waiting time ends with the end of the period of the reset ramp signal REFR. Starting with the end of the waiting time, the pixel circuit 100 can request the next readout. For the temporary suppression of outputting the request signal, the reset latch circuit 180 may receive further control signals through the control bus 31 and/or through the ramp control bus 21.

The reset latch circuit 180 may also be configured to suppress a further output of event data for the period starting after information about the predefined change in illumination has been read out until the end of the following complete period of the reset ramp signal REFR. The following complete period may be the next complete period or another one of the following periods.

For example, a first output of the pixel comparator circuit 130 outputs an ON signal indicating an ON event and controlling a first output switch 191. A controlled path of the first output switch 191 is between the first data signal line 42 and a common data node. A second output of the pixel comparator circuit 130 outputs an OFF signal indicating an OFF event and controlling a second output switch 192. A controlled path of the second output switch 192 is between the second data signal line 43 and the common data node. The row select signal SEL<x> controls a third output switch 193 with a controlled path between the common data node and a reference potential VSS. The reset latch circuit 180 may temporarily suppress the output of event data by interrupting a connection between the third output switch 193 and the reference potential VSS.

In particular, the reset latch circuit 180 may be configured to output a read done signal RDDN indicating that the pixel circuit 100 has detected a predefined change in illumination, and that information about the predefined change in illumination has been read out from the pixel circuit 100.

The read done signal RDDN can be used to suppress the output of the request signal REQ and/or to generate a further signal indicating the autozero period.

In addition, the reset latch circuit 180 may be configured to output an autozero signal AZ indicating start and end of a complete period of the reset ramp signal REFR following the detection of a predefined change in illumination the pixel circuit 100.

Start and end of the active autozero signal AZ define the autozero interval. The reset ramp signal REFR is applied to the gate of the reset switch 126 from the start of the autozero interval until the end of the autozero interval. The autozero signal AZ can be used to suppress the output of the request signal for the autozero interval and/or to suppress the output of the event data ON, OFF for the autozero interval. In other words, once a pixel circuit 100 has detected an event by detecting a predefined change in illumination and has been read out, the read done signal RDDN and the autozero signal AZ can be used to prevent the pixel circuit 100 from outputting an active request signal in a period starting with the pixel readout and ending at the end of the autozero interval used for autozeroing the pixel circuit 100.

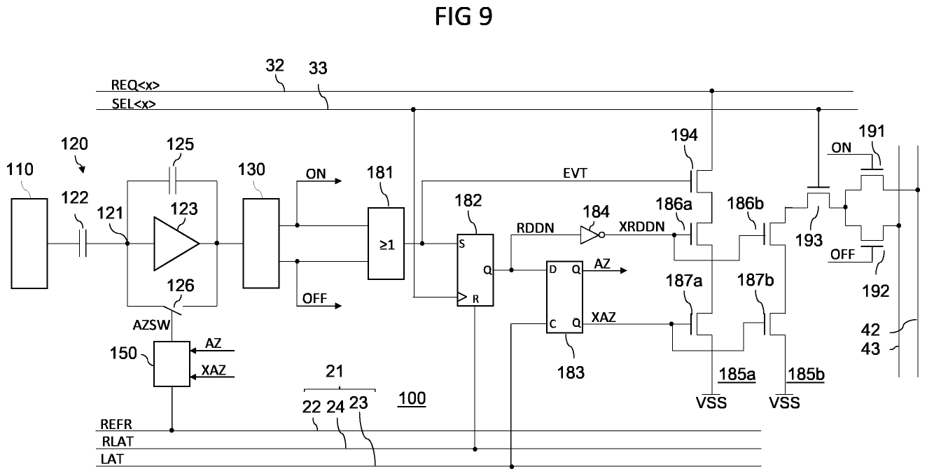

In FIG. 9, the reset latch circuit 180 receives a latch signal LAT and a reset latch signal RLAT to generate the read done signal RDDN and the autozero signal AZ. An active level of the reset latch signal RLAT follows an active level of the latch signal LAT. The leading edge of the reset ramp signal REFR follows the active reset latch signal RLAT. The latch signal LAT and the reset latch signal RLAT may be global signals applied to all pixel circuits 100 synchronously. Alternatively, the reset latch signal RLAT may be obtained by delaying the latch signal LAT in each pixel circuit 100.

The ramp control bus 21 or the control bus 31 transmits the latch signal LAT on a latch signal line 23 and the reset latch signal RLAT on a reset latch signal line. The latch signal LAT and the reset latch signal RLAT are synchronous with respect to the reset ramp signal REFR.

Referring again to FIG. 7, the latch signal LAT may be active between t=t0 and t=t1. The reset latch signal RLAT becomes active later than the latch signal LAT, e.g., between t=t1 and t=t2. The leading edge of the reset ramp signal REFR is not before t=t2. The trailing edge starts at t=t3 and ends at t=t4. The autozero interval starts at t=t0 and ends at t-t0 of the next autozero interval.

Referring again to FIG. 9, the reset latch circuit 180 generates an event signal EVT indicating that either an ON event or an OFF event is detected. For example, an OR gate 181 may combine the ON signal and the OFF signal to the event signal EVT.

The reset latch circuit 180 includes an edge sensitive (clocked) master-slave FF (flipflop) 182 with a set input S, a reset input R, a clock input, and a non-inverting output Q. The event signal EVT indicates a predefined increase or decrease in illumination and is applied to the set input S. A row select signal SEL<x> is applied to the clock input. At the same time, the row select signal SEL<x> enables the output of the event data on the event data lines 42, 43. At the non-inverting output, the master-slave FF 182 outputs a read done signal RDDN. The read done signal RDDN changes between an inactive state and an active state. The active state of the read done signal RDDN indicates that the pixel circuit 100 has received the row select signal ACK<x> and that the pixel circuit 100 had detected an event before it has received the row select signal ACK<x>, and that the autozeroing has not yet ended. An inverter 184 generates the inverted read done signal XRDN by inverting the read done signal RDDN. Alternatively, the inverted read done signal may come from an inverting output of maser-slave FF 182.

The reset latch circuit 180 may further include a level-sensitive D-FF 183 with a data input D, a clock input, a non-inverting output Q and/or an inverting output/Q. The level-sensitive D-FF 183 is controlled by the voltage level at the clock input. The read done signal RDDN is applied to the data input D. The latch signal LAT is applied to the clock input. The D-FF 183 outputs an autozero signal AZ at the non-inverting output Q. The D-FF 183 outputs an inverted autozero signal XAZ at the inverting output/Q. The autozero signal AZ changes between an inactive level and an active level. The inverted autozero signal XAZ changes between an inactive level and an active level.

A rising edge of the latch signal LAT indicates the start of an autozeroing interval. Shortly after the latch signal LAT has become active, the reset latch signal RLAT may become active and may reset the master-slave FF 182.

The autozero signal AZ and/or the inverted autozero signal XAZ control an autozero enable switch 150. When the autozero signal AZ is active and/or the inverted autozero signal XAZ is inactive, the autozero enable switch 150 passes the reset ramp signal REFR to the control electrode of the reset switch 126. The reset switch 126 may be an NFET and the control electrode the gate of the NFET.

The active level of the autozero signal AZ indicates that autozeroing is in process for a pixel circuit 100 that has detected an event and that has been read out.

The reset latch circuit 180 further includes a switching circuit 185 configured to disable the request signal REQ in case the autozero signal AZ and/or the read done signal RDDN is active. For example, the switching circuit 185 disables a transmission of the request signal REQ from the pixel circuit 100 to the row arbiter when at least one of the autozero signal AZ and the read done signal RDDN is active.

The event signal EVT is applied to a gate of a request output transistor 194. A controlled path of the request output transistor 194 is between the request signal line 32 and a first controllable path 185a of the switching circuit 185. A pull-up resistor (not illustrated) terminates the request signal line 32. The first controllable path 185a of the switching circuit 185 is electrically connected between the request output transistor 194 and the reference potential VSS. The first controllable path 185a of the switching circuit 185 can be controlled to avoid a request during autozeroing.

A second controllable path 185b of the switching circuit 185 can be used to avoid a second readout before autozeroing is completed.

In FIG. 9, the first controllable path 185a of the switching circuit 185 includes a first NFET 186a and a second NFET 187a. Load paths of the first NFET 186a and the second NFET 187a are electrically connected in series between the controlled path of the request output transistor 194 and the reference potential VSS. The inverted read done signal XRDDN is applied to the gate of the first NFET 186a and controls the first NFET 186a. The inverted autozero signal XAZ is applied to the gate of the second NFET 187a and controls the second NFET 187a.

Both the inverted autozero signal XAZ and the inverted read done signal XRDDN must be active (and both the autozero signal AZ and the read done signal RDDN inactive) to enable the output of the request signal REQ.

The second controllable path 185b of the switching circuit 185 includes a third NFET 186b and a fourth NFET 187b. Load paths of the third NFET 186b and the fourth NFET 187b are electrically connected in series between the controlled path of the third output switch 193 and the reference potential VSS. The inverted read done signal XRDDN is applied to the gate of the third NFET 186b and controls the third NFET 186b. The inverted autozero signal XAZ is applied to the gate of the fourth NFET 187b and controls the fourth NFET 187b.

Both the inverted autozero signal XAZ and the inverted read done signal XRDDN must be active (and both the autozero signal AZ and the read done signal RDDN inactive) to enable output of event data.

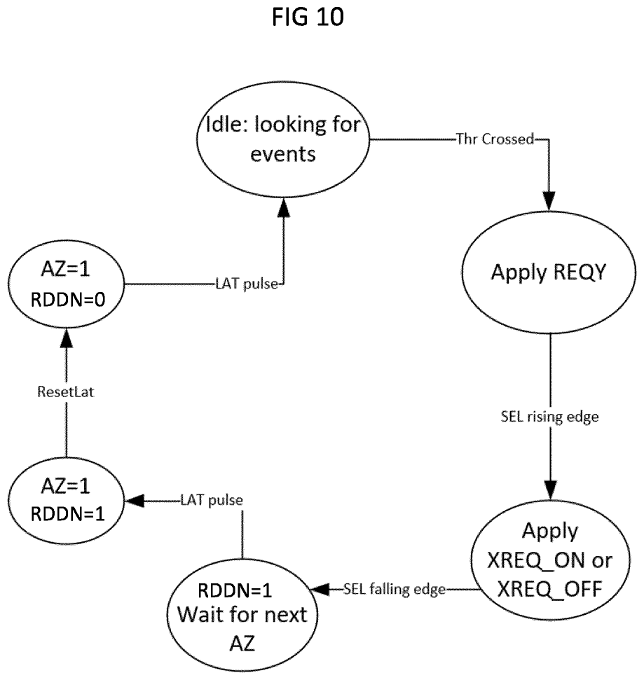

FIG. 10 shows a state diagram of the pixel circuit 100 illustrated in FIG. 9. In an idle state, the pixel circuit 100 waits for events. When the voltage at the input of the pixel comparator circuit crosses the upper or lower threshold, the pixel circuit applies an active group request signal to the control bus. When the pixel circuit detects that a group select signal on the control bus becomes active, the pixel circuit applies the ON signal or the OFF signal to the event data bus. When the group select signal becomes inactive, the pixel circuit stops outputting the ON signal and the OFF signal, sets the read done signal RDDN to the active level and waits for an active latch signal. The active latch signal indicates the start of the next autozeroing interval. When the pixel circuit receives an active latch signal, the pixel circuit sets the autozero signal AZ to the active level, turns on and off the reset switch, and waits for an active reset latch signal. When the pixel circuit receives an active reset latch signal, the pixel circuit sets the read done signal RDDN to the inactive level and waits for the next active latch signal. When the pixel circuit receives the next active latch signal, the reset switch has opened smoothly. The pixel circuit sets the autozero signal AZ to the inactive level and returns to the idle state.

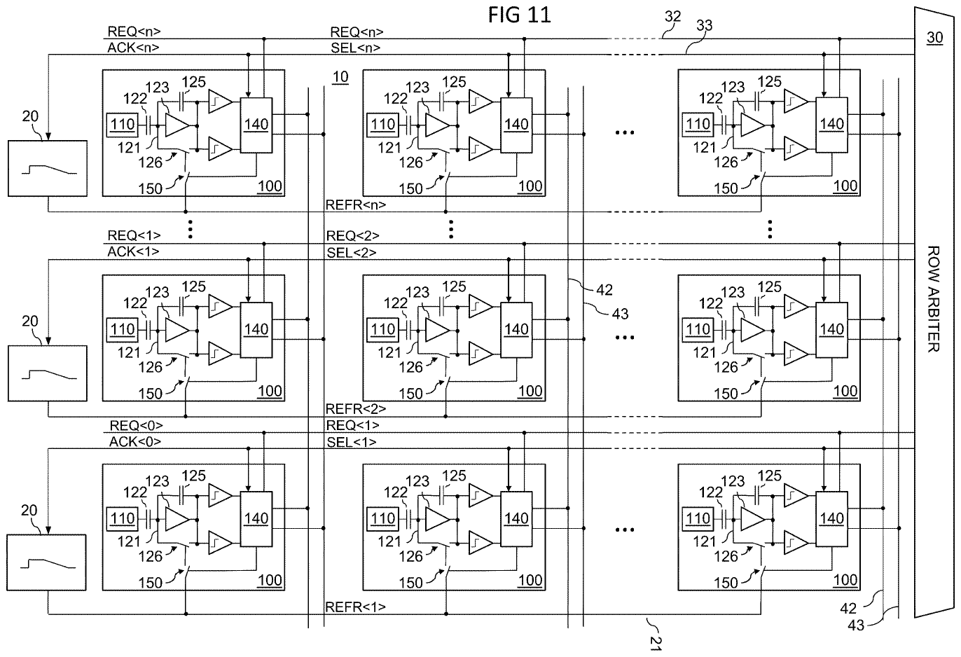

FIG. 11 shows an image sensor including groups of pixel circuits 100, wherein the pixel circuits 100 of each group share a common group ramp signal REFR<x>.

The row arbiter 30 outputs a group select signal SEL<x> to a first group of the pixel circuits 100 in response to a group request signal REQ<x> received from any of the pixel circuits 100 of the first group. That is, for each group of pixel circuits 100, the row arbiter 30 can receive a group request signal REQ<x> from any of the pixel circuits 100 of the group and in response to the received group request signal REQ<x> the row arbiter 30 outputs a group select signal SEL<x> to each pixel circuit 100 of the concerned group. Each group of pixel circuits 100 may include some or all pixel circuits 100 of one pixel row, or some or all pixel circuits 100 of more than one pixel row.

The ramp signal circuit 20 outputs the reset ramp signal REFR<x> for the first group of the pixel circuits 100 in response to the group select signal SEL<x> for the first group of pixel circuits 100.

The reset ramp signal REFR<x> for the first group of the pixel circuits 100 is a group-specific reset ramp signal (“group reset ramp signal”) REFR<x>. The group select signal SEL<x> and the group-reset ramp signal REFR<x> have a fixed time relationship to each other, wherein the group select signal SEL<x> triggers the group reset ramp signal REFR<x>.

When the pixel circuits 100 are assigned to pixel rows and pixel columns, the first group of the pixel circuits 100 can be assigned to one of the pixel rows or to one of the pixel columns.

Each pixel logic circuit 140 includes a reset latch circuit 180 that controls the autozeroing process based on the group select signal SEL<x> and the group reset ramp signal REFR<x>.

In the illustrated embodiments, each pixel group includes all pixel circuits 100 of the same pixel row. Accordingly, the group select signal SEL<x> is denominated as row select signal SEL<x>, the group request signal REQ<x> is denominated as row request signal REQ<x>, and the group reset ramp signal REFR<x> is denominated as row reset ramp signal REFR<x>.

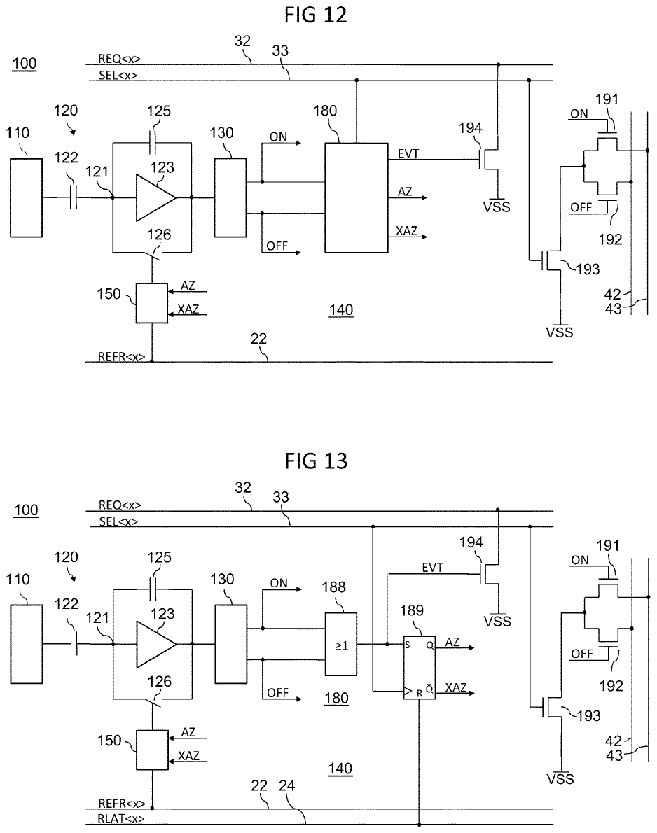

FIG. 12 shows a pixel circuit 100 with a reset latch circuit 180 suitable for the image sensor of FIG. 11.

The reset latch circuit 180 outputs an autozero signal AZ indicating that the pixel circuit 100 has detected a predefined change in illumination, information about the predefined change in illumination has been read out and initialization of the floating node 121 is not complete.

The autozero signal AZ can be used to selectively pass the reset ramp signal REFR to the reset switch 126 only once the pixel circuit 100 has detected the predefined change in illumination. The reset ramp signal REFR is not passed to the reset switches 126 of such pixel circuits 100 of the same group that have not detected a predefined change in illumination. Pixel circuits 100 of the same group that have not detected a predefined change in illumination remain unaffected from the readout and autozeroing of the pixel circuits 100 that have requested an event data readout.

In addition to the autozero signal AZ, the reset latch circuit 180 may output the inverted autozero signal XAZ. The inverted autozero signal XAZ may also be used to control the transmission of the reset ramp signal REFR from a ramp signal line 22 to the control input of the reset switch 126.

In FIG. 13 the reset latch circuit 180 includes an OR gate 188 and an edge sensitive master slave FF 189.

A first output of the pixel comparator circuit 130 is connected to a first input of the OR gate 188. A second output of the pixel comparator circuit 130 is connected to a second input of the OR gate 188. The OR gate 188 combines the ON signal and the OFF signal and outputs an event signal EVT. The event signal EVT is active when at least one of the ON signal and the OFF signal is active.

The output of the OR gate 188 is connected to a gate of the request output transistor 194 and a set input of the master slave FF 189. An active event signal EVT turns on the request output transistor 194 and can set the master slave FF 189. The acknowledgment line 33 is connected to the clock input of the master slave FF 189. With the leading edge of an active row select signal SEL<x> the master slave FF 189 captures the signal at the set input S. A reset latch line 24 is connected to the reset input R. An active reset latch signal RLAT<x> transmitted on the reset latch line 24 resets the master slave FF 189. The non-inverted output Q outputs the autozero signal AZ. The inverted output/Q outputs the inverted autozero signal AZ.

That is, each pixel circuit 100 includes a reset latch circuit 180 that outputs an autozero signal AZ in response to a predefined change in illumination. Each pixel circuit 100 further includes an autozero enable switch 150 to pass the reset ramp signal REFR to the reset switch 126 in response to the autozero signal AZ. The autozero signal AZ can be used to control the autozero enable switch 150.

For example, the autozero enable switch 150 receives the reset ramp signal REFR and outputs an autozero switching signal AZSW obtained by gating the reset ramp signal REFR with the autozero signal AZ. The autozero switching signal AZSW is applied to the gate of the reset transistor 126.

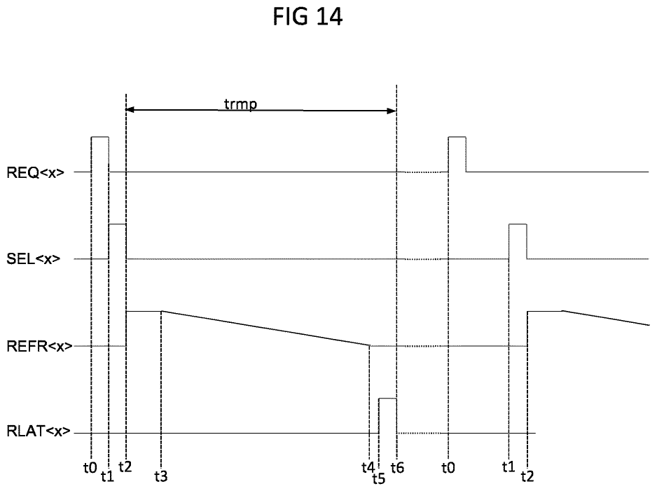

FIG. 14 shows a time diagram for an event data readout and the subsequent autozero interval. At t=t0 one of the pixel circuits of a group of pixel circuits sets an active group request signal REQ<x> illustrated with active high level for simplicity. At t=t1 the row arbiter sets the group select signal SEL<x> of the concerned group to the active level. In response to the active group select signal SEL<x>, the reset latch circuit 180 switches the group request signal REQ<x> to the inactive level. After the event data is read out, the row arbiter switches the group select signal SEL<x> to the inactive level at t=t2. At t=t2 or later, the autozero interval starts by setting the reset ramp signal to an active level. The reset switch turns on and the floating node is set to the initial potential. Starting from t=t3, the reset ramp signal falls at a comparatively low rate and reaches the inactive level at t=t4.

While the leading edge of the reset ramp signal REFR can be as fast as the technology used for the image sensor allows, the slope of the trailing edge is controlled and longer (e.g. by at least one order of magnitude) than a minimum length given by technical limitations. The duration of the trailing edge can be controllable by device settings.

A trailing edge of the reset ramp signal REFR changes at a rate at least ten times slower than a leading edge of the group select signal SEL<x>.

For example, the trailing edge of the reset ramp signal REFR changes at a rate at least twenty, fifty or hundred times slower than the leading edge of the group select signal SEL<x>. The slow change at the gate causes the reset switch to turn off smoothly. At t=t4 or later the row arbiter changes the group reset latch signal RLAT<x> to an active level to reset the master slave FF 189. The autozero interval ends when the group reset latch signal RLAT<x> returns to the inactive level at t=t6.

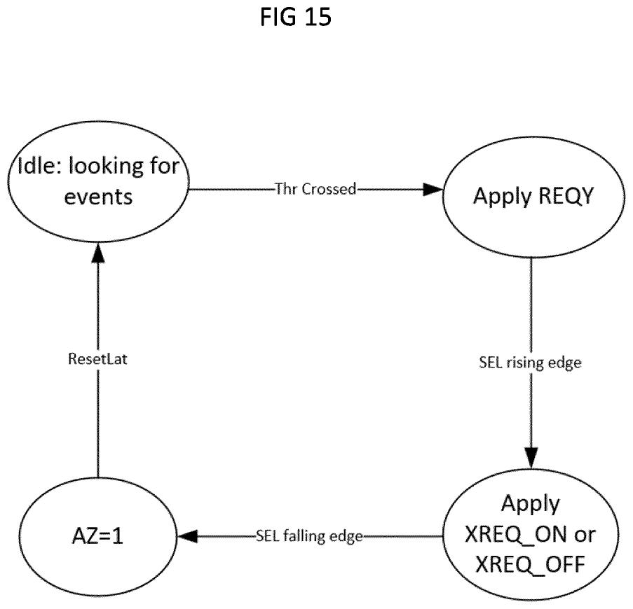

FIG. 15 shows a state diagram of the pixel circuit 100 illustrated in FIG. 13. In an idle state, the pixel circuit 100 waits for events. When the voltage at the input of the pixel comparator circuit crosses the upper or lower threshold, the pixel circuit applies an active group request signal to the control bus. When the pixel circuit detects that a group select signal SEL<x> on the control bus becomes active, the pixel circuit applies the ON signal or the OFF signal to the event data bus. When the group select signal SEL<x> becomes inactive, the pixel circuit stops outputting the ON signal and the OFF signal, sets the autozero signal AZ to the active level and waits for an active reset latch signal. The active autozero signal indicates the start of the autozeroing interval. When the pixel circuit receives an active reset latch signal, the reset switch has turned off smoothly. The pixel circuit sets the autozero signal AZ to the inactive level and returns to the idle state.

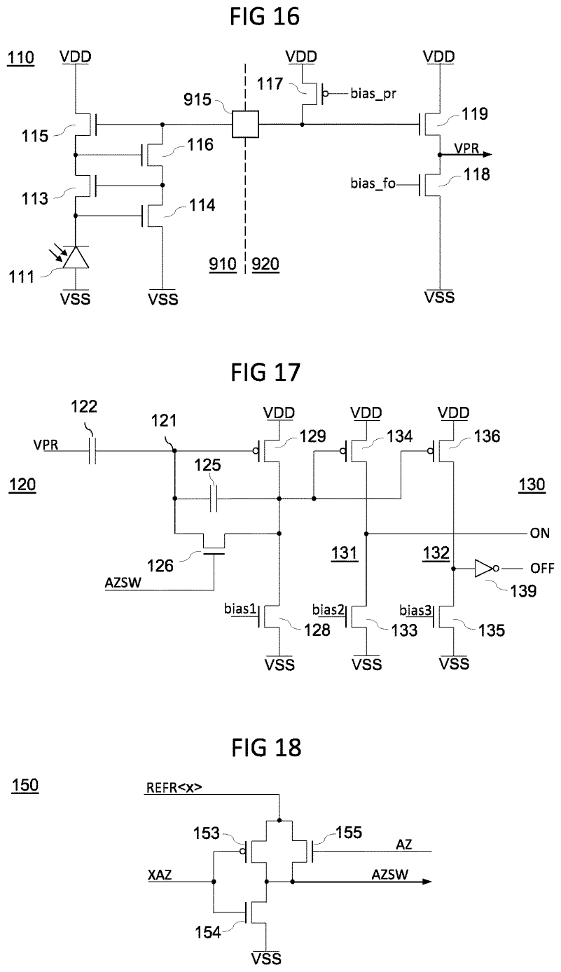

FIG. 16 shows a configuration example of a radiation sensitive circuit 110 including a photoelectric conversion element 111, a multiple transistor feedback logarithmic amplifier circuit (LAC) and a source follower.

The anode of the photoelectric conversion element 111 is electrically connected to the reference potential VSS. The LAC includes a first amplifier NFET 115 and a second amplifier NFET 113 electrically connected in series between a positive supply potential VDD and the cathode of the photoelectric conversion element 111. A pull-up PFET (p channel FET) 117 with constantly biased gate, a third amplifier NFET 116 and fourth amplifier NFET 114 are electrically connected in series between the positive supply potential VDD and the reference potential VSS. The gate of the fourth amplifier NFET 114 is connected to the cathode of the photoelectric conversion element 111. The gate of the second amplifier NFET 113 is connected to a node between the third amplifier NFET 116 and the fourth amplifier NFET 114. The gate of the third amplifier NFET 116 is connected to a node between the first amplifier NFET 115 and the second amplifier NFET 113. The gate of the first amplifier NFET 115 is connected to a LAC output node between the pull-up PFET 117 and the third amplifier NFET 116.

The source follower includes a source follower NFET 119 and a load NFET 118 with constantly biased gate electrically connected in series between the positive supply potential VDD and the reference potential VSS. The LAC output node is electrically connected to the gate of the source follower NFET 119. The source follower outputs the pixel voltage signal VPR. The source follower forms a near-unity-gain voltage buffer that isolates the LAC from the capacitive amplifier circuit 120.

As mentioned with reference to FIG. 3, the image sensor may include a radiation receiving chip 910 and a processing chip 920. The radiation receiving chip 910 can include the photoelectric conversion element 111 and the NFETs of the logarithmic amplifier. The processing chip 920 may include the pull-up PFET 117 and the source follower. One through contact via 915 per pixel circuit passes the signal from the radiation receiving chip 910 to the processing chip 920.

Other examples of the radiation sensitive circuit 110 may be based on a basic configuration of a logarithmic amplifier with an inverting amplifier and a feedback element with logarithmic current-to-voltage relation that is connected between an input and an output of the inverting amplifier. The inverting amplifier ensures that a voltage across the photoelectric conversion element 111 is approximately constant. The pixel voltage signal VPR shows a logarithmic dependence on the photocurrent of the photoelectric conversion element 111.

FIG. 17 shows a configuration example of a combination of a capacitive amplifier circuit 120 and a pixel comparator circuit 130.

The capacitive amplifier circuit 120 includes a switched capacitor amplifier including a storage capacitor 122, a feedback capacitor 125, a reset switch 126 and an inverting amplifier circuit. As regards the storage capacitor 122, the feedback capacitor 125 and the reset switch 126, reference is made to the description of FIG. 5. The inverting amplifier circuit includes a first PFET 129 and a first load NFET 128, wherein load paths of the first PFET 129 and the first load NFET 128 are electrically connected in series between the positive supply potential VDD and the reference potential VSS. The gate of the first PFET 129 is connected to the floating node 121. The gate of the first load NFET 128 receives a constant bias voltage bias1. The inverting amplifier circuit outputs an amplified signal at the node between the first PFET 129 and the first load NFET 128. A voltage gain of the inverting amplifier circuit is substantially larger than a ratio of the capacitance of the storage capacitor 122 to the capacitance of the feedback capacitor 125.

The pixel comparator circuit 130 includes a first comparator 131, a second comparator 132, and an inverter circuit 139.

The first comparator 131 includes a first comparator PFET 134 and a first threshold NFET 133, wherein load paths of the first comparator PFET 134 and the first threshold NFET 133 are electrically connected in series between the positive supply potential VDD and the reference potential VSS. The gate of the first comparator PFET 134 receives the output signal of the capacitive amplifier circuit 120. A constant second bias voltage bias2 is applied to the gate of the first threshold NFET 133.

The second comparator 132 includes a second comparator PFET 136 and a second threshold NFET 135, wherein load paths of the second comparator PFET 136 and the second threshold NFET 135 are electrically connected in series between the positive supply potential VDD and the reference potential VSS. The gate of the second comparator PFET 136 receives the output signal of the capacitive amplifier circuit 120. A constant third bias voltage bias3 is applied to the gate of the second threshold NFET 135. The channel widths of the first comparator PFET 134 and the first threshold NFET 133 may be selected such that when the output signal of the capacitive amplifier circuit 120 rises above a certain threshold, the first comparator 131 outputs a high voltage level active ON signal at a first output node between the first comparator PFET 134 and the first threshold NFET 133. Otherwise, the first comparator 131 outputs a low voltage level at the first output node. The channel widths of the second comparator PFET 136 and the second threshold NFET 135 are selected such that when the output signal of the capacitive amplifier circuit 120 falls below a certain threshold, the second comparator 132 outputs a low-level voltage signal at an internal output node between the second comparator PFET 136 and the second threshold NFET 135. Otherwise, the second comparator 132 outputs a high voltage level at the internal output node.

Alternatively, the channel widths of the first comparator PFET 134 and the second comparator PFET 136 may be equal, and the channel widths of the first threshold NFET 133 and the second threshold NFET 135 may be equal, and the biases bias2, bias3 on the gates of the first threshold NFET 133 and the second threshold NFET 135 are chosen such that when the output signal of the capacitive amplifier circuit 120 rises above a certain threshold, the first comparator 131 outputs a high voltage level active ON signal at the first output node between the first comparator PFET 134 and the first threshold NFET 133, and when the output signal of the capacitive amplifier circuit 120 falls below a certain threshold, the second comparator 132 outputs a low-level voltage signal at the internal output node between the second comparator PFET 136 and the second threshold NFET 135. The first pFET 129 may have the same channel width as the first comparator PFET 134 and the second comparator PFET 136.

The inverter circuit 139 inverts the signal at the internal output node such that the second comparator 132 outputs an active high voltage level OFF signal when the output signal of the capacitive amplifier circuit 120 falls below the certain threshold.

FIG. 18 shows a configuration example of the autozero enable switch 150.

The autozero enable switch 150 includes an NFET 155 and a PFET 153 electrically connected in parallel between an output of the ramp signal circuit 20 and a control input of the reset switch 126.

More particularly, the controlled load paths between source and drain of the NFET 155 and source and drain of the PFET 153 are electrically connected in parallel. The NFET 155 and the PFET 153 are configured as transmission gate working as analog switch. The bulk of the PFET 153 may be connected to a positive potential. The bulk of the NFET 155 may be connected to the reference potential VSS.

The autozero signal AZ is applied to the gate of the NFET 155. For example, the non-inverting output Q of the master slave FF 189 of FIG. 13 is connected to the gate of the NFET 155. The inverted autozero signal XAZ is applied to the gate of the PFET 153. For example, the inverting output /Q of the master slave FF 189 of FIG. 13 is connected to the gate of the PFET 153. At a first side of the parallel load paths, the group reset ramp signal REFR<x> is applied. At the second side of the parallel load paths, an autozero switch signal is obtained that is applied to the control electrode of the reset switch in the pixel circuit.

The controlled load path of an auxiliary NFET 154 may be connected between the control input of the reset switch 126 and the reference potential VSS. The inverted autozero signal XAZ is applied to the gate of the auxiliary NFET 154. The auxiliary NFET 154 holds the autozero switching signal AZSW fixed at the reference potential VSS when the autozero signal AZ has a low level and the inverted autozero signal XAZ has a high level, and prevents the reset switch 126 from being inadvertently turned on.

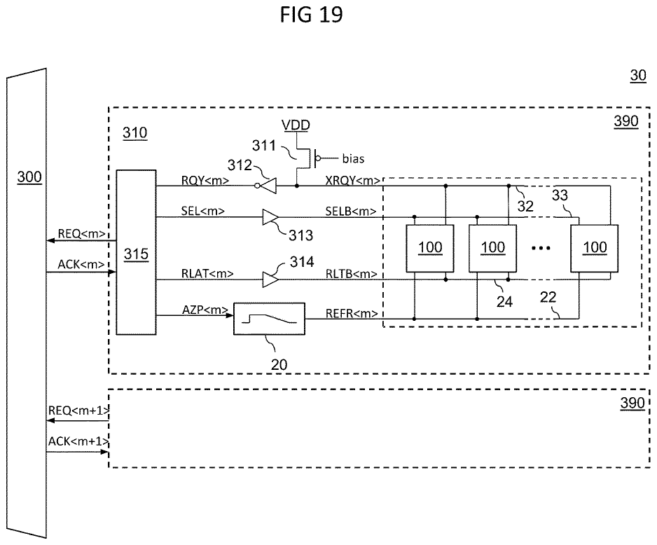

FIG. 19 shows a row arbiter 30 that includes an arbitration circuit 300 and a plurality of arbiter interface circuits 310, wherein each arbiter interface circuit 310 is assigned to one group of pixel circuits 100, e.g., to all pixel circuits 100 of one pixel row. One group of pixel circuits 100 and the associated arbiter interface circuit 310 form an interfaced pixel group 390.

The arbiter interface circuit 310 includes an inverting circuit 312 and a request pull-up transistor 311 terminating the request signal line 32. The request signal line 32 transmits an active low group request signal XRQY<m> from the pixel circuits 100 to the inverting circuit 312. The inverting circuit 312 converts the active low group request signal XRQY<m> into an active high group request signal RQY<m>. A group interface circuit 315 receives the active high group request signal RQY<m> and passes a group request signal REQ<m> to the arbitration circuit 300.

The arbitration circuit 300 responds to various group request signals REQ<m> by transmitting group acknowledgement signals ACK<m> in a sequence resulting from a predefined priority scheme.

In response to a received acknowledgement signal ACK<m>, the group interface circuit 315 generates an unbuffered group select signal SEL<m>, an unbuffered group reset latch signal<m>, and a group autozero start signal AZP<m>.

A first buffer circuit 313 receives the unbuffered group select signal SEL<m> and outputs a buffered group select signal SELB<m> on the acknowledgement signal line 33. A second buffer circuit 314 receives the unbuffered group reset latch signal RLAT<m> and outputs a buffered group reset latch signal RLTB<m> on a reset latch signal line 24. The group autozero start signal AZP<m> controls the ramp signal circuit 20 to start outputting the group reset ramp signal REFR<m> on the ramp signal line 22.

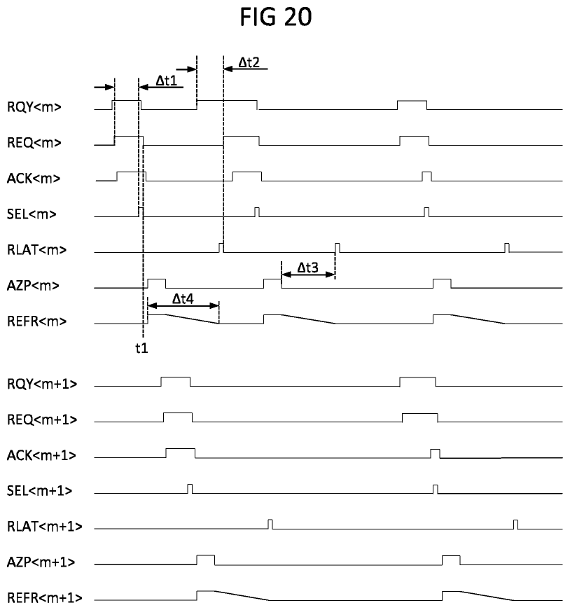

FIG. 20 shows a time diagram for the signals in FIG. 19. A minimum read wait period Δt1 between the leading edge of the group request signal REQ<m> and the leading edge of the group select signal SEL<m> can be defined in the group interface circuit 315 to give other pixel circuits 100 of the same group the opportunity to detect a predefined change in illumination. Then, more pixel circuits 100 can be read out in the same readout.

At t=t1 the group interface circuit 315 can set the grout request signal REQ<m> to the inactive level simultaneously with the group select signal SEL<m> provided that the active high group request signal RQY<m> at the input of the group interface circuit 315 has the low level.

The period Δt2 shows an example where the group interface circuit 315 ignores an active high group request signal RQY<m> until an ongoing autozeroing is completed as indicated by the trailing edge of an active pulse of the group reset latch signal RLAT<m>.

The period Δt3 between the trailing edge of the group autozero start pulse AZP<m> and the leading edge of the group reset latch signal RLAT<m> can be configurable. The widths of the active pulses of the group reset latch signal RLAT<m>, the group select signal SEL<m>, and the group autozero signal AZP<m> may be configurable in the group interface circuit 315.

Finally, the time diagram shows that during the autozeroing of pixel group m in period Δt4, pixel group m+1 can be read out.

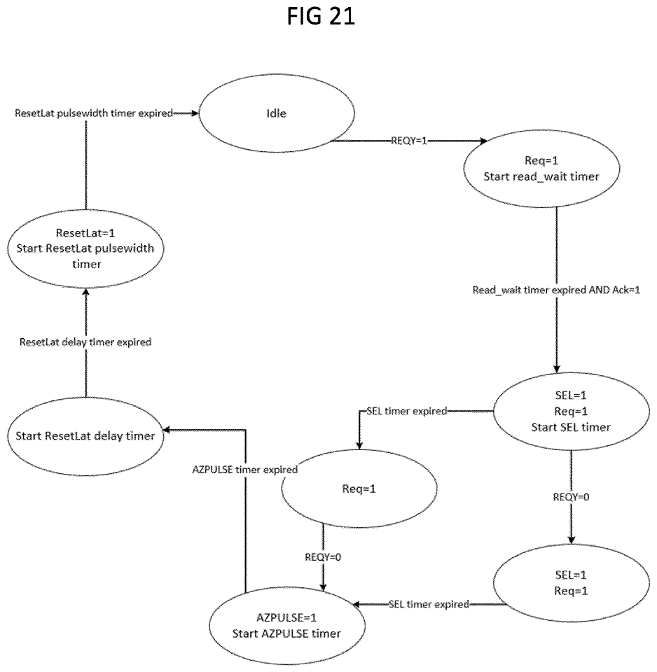

FIG. 21 shows an exemplary state diagram for the operation of a group interface circuit 315 as illustrated in FIG. 19.

The group interface circuit wakes up from an idle state by receiving an active high group request signal RQY<m>. The group interface circuit outputs an active group request signal REQ<m> to the arbitration circuit and starts a read wait timer. When the read wait timer is expired and a group acknowledgement signal ACK<m> is received, the group interface circuit 315 sets the group select signal SEL<m> to the active level, starts a select timer and waits for that the active high group request signal RQY<m> gets inactive. When the select timer expires, the group interface circuit 315 sets the group select signal SEL<m> inactive.

When the select timer expires before the active high group request signal RQY<m> gets inactive, the group interface circuit 315 starts an autozero pulse timer and sets the group autozero start signal AZP<m> when the active high group request signal RQY<m> gets inactive.

When the select timer expires after the active high group request signal RQY<m> gets inactive, the group interface circuit 315 starts an autozero pulse timer and sets the group autozero start signal AZP<m> when the select timer expires.

When the autozero pulse timer expires, the group interface circuit 315 sets the group autozero start signal AZP<m> inactive and starts a reset latch delay timer.

When the reset latch delay timer expires, the group interface circuit 315 sets the group reset latch signal RLAT<m> active and starts a reset latch pulse width timer.

When the reset latch pulse width timer expires, the group interface circuit 315 sets the group reset latch signal RLAT<m> inactive and returns to the idle state.

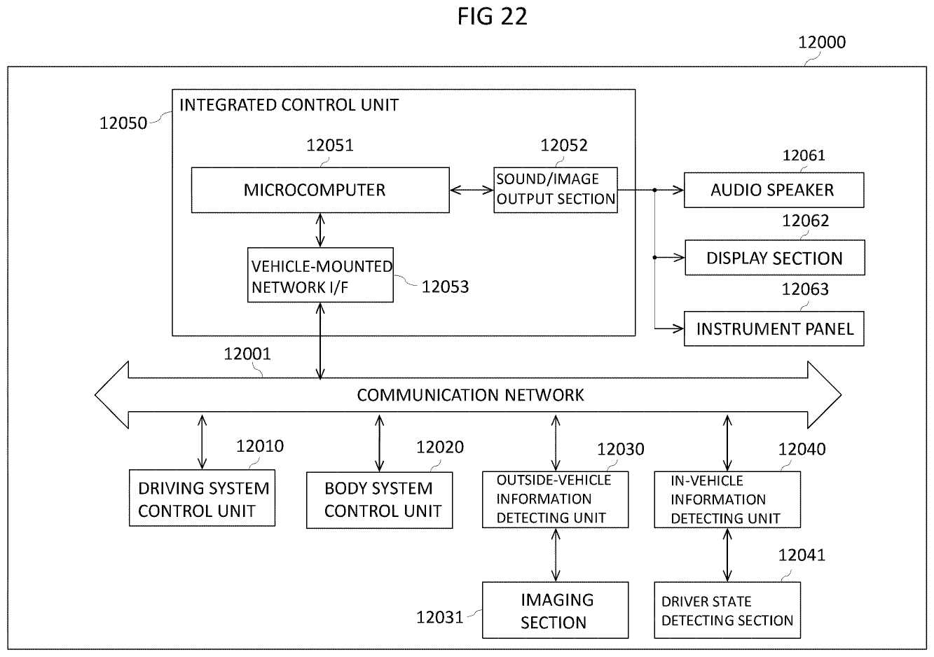

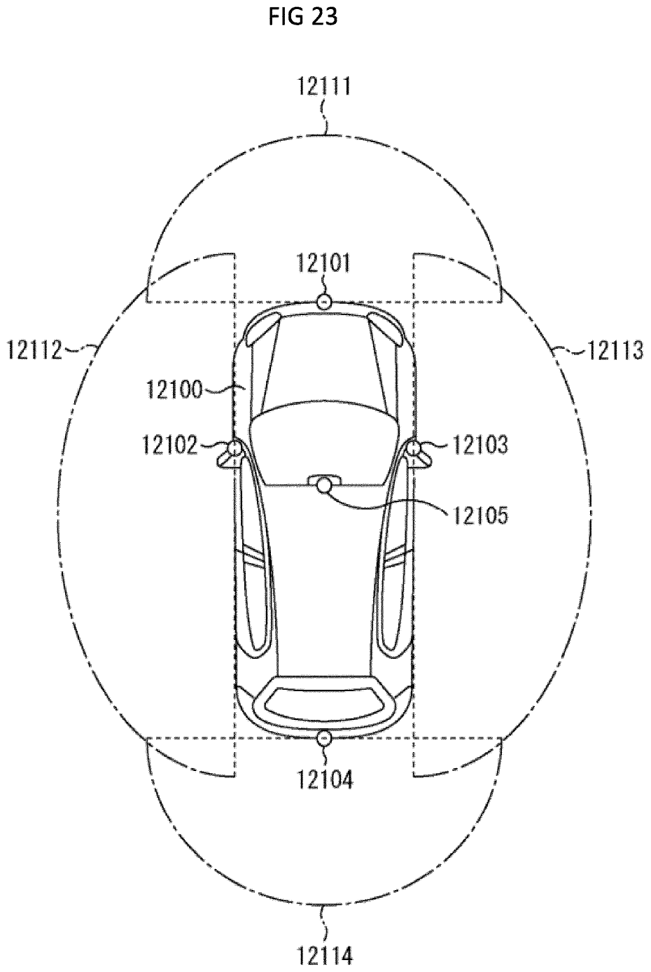

FIG. 22 is a block diagram depicting an example of schematic configuration of a vehicle control system as an example of a system to which the technology according to an embodiment of the present disclosure can be applied.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include an image sensor or a solid-state imaging device with an image sensor according to the embodiments of the present disclosure. The light received by the imaging section 12031 may be visible light or may be invisible light such as infrared rays or the like.

The in-vehicle information detecting unit 12040 detects information about the inside of the vehicle and may be or may include an image sensor or a solid-state imaging device with an image sensor according to the embodiments of the present disclosure. The in-vehicle information detecting unit 12040 is, for example, connected with a driver state detecting section 12041 that detects the state of a driver. The driver state detecting section 12041, for example, includes a camera that includes the solid-stage imaging device and that is focused on the driver. On the basis of detection information input from the driver state detecting section 12041, the in-vehicle information detecting unit 12040 may calculate a degree of fatigue of the driver or a degree of concentration of the driver or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display or a head-up display.

FIG. 23 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 23 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including an image sensor or a solid-state imaging device with an image sensor according to the embodiments of the present disclosure.

For example, the microcomputer 12051 can determine a distance to each three-dimensional object within the imaging ranges 12111 to 12114 and a temporal change in the distance (relative speed with respect to the vehicle 12100 on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying an image sensor or a solid-state imaging device with an image sensor according to the embodiments of the present disclosure, the sensors have improved time resolution and sensing performance.

Additionally, embodiments of the present technology are not limited to the above-described embodiments, but various changes can be made within the scope of the present technology without departing from the gist of the present technology.

The image sensor according to the present disclosure may be any device used for analyzing and/or processing radiation such as visible light, infrared light, ultraviolet light, and X-rays. For example, a solid-state imaging device including an image sensor according to the embodiments may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device including an image sensor according to the embodiments may be a device for capturing an image to be provided for appreciation, such as a digital camera, a smart phone, or a mobile phone device having a camera function. In the field of traffic, for example, the solid-state imaging device including an image sensor according to the embodiments may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the image sensor according to the embodiments may be integrated in any type of sensor that can be used in devices provided for home appliances such as TV receivers, refrigerators, and air conditioners to capture gestures of users and perform device operations according to the gestures. Accordingly the image sensor according to the embodiments may be integrated in home appliances such as TV receivers, refrigerators, and air conditioners and/or in devices controlling the home appliances. Furthermore, in the field of medical and healthcare, the image sensor according to the embodiments may be integrated in any type of sensor, e.g. a solid-state image device, provided for use in medical and healthcare, such as an endoscope or a device that performs angiography by receiving infrared light.

In the field of security, the image sensor according to the embodiments can be integrated in a device provided for use in security, such as a monitoring camera for crime prevention or a camera for person authentication use. Furthermore, in the field of beauty, an image sensor according to the embodiments can be used in a device provided for use in beauty, such as a skin measuring instrument that captures skin or a microscope that captures a probe. In the field of sports, an image sensor according to the embodiments can be integrated in a device provided for use in sports, such as an action camera or a wearable camera for sport use or the like. Furthermore, in the field of agriculture, the image sensor can be used in a device provided for use in agriculture, such as a camera for monitoring the condition of fields and crops.

The present technology can also be configured as described below:
[1] An image sensor (80), including: a pixel array (10) including pixel circuits (100), wherein each pixel circuit (100) is configured to output a request signal in response to a predefined change in illumination, wherein each pixel circuit (100) includes a floating node (121) configured to temporally store charge as a function of a change of an illumination condition, and wherein each pixel circuit (100) includes a reset switch (126) configured to set the floating node (121) to a predefined initial potential in response to a reset ramp signal; and a ramp signal circuit (20) configured to output the reset ramp signal for at least a first group of the pixel circuits (100).
[2] The image sensor according to [1], wherein the pixel circuits (100) are configured such that, for each pixel circuit (100), the reset ramp signal is passed to the reset switch (126) only for a period of time after detection of a predefined change in illumination in the pixel circuit (100) and before an end of setting the initial potential of the floating node (121).
[3] The image sensor according to any of [1] and [2], wherein the ramp signal circuit (20) is configured to output the reset ramp signal at regular time intervals.
[4] The image sensor according to any of [1] to [3], wherein the ramp signal circuit (20) is configured to output the reset ramp signal for each pixel circuit (100) of the pixel array (10).
[5] The image sensor according to any of [1] to [4], wherein each of the pixel circuits (100) includes a reset latch circuit (180) configured to suppress an output of the request signal for a period starting after information about the predefined change in illumination has been read out until an end of a following complete period of the reset ramp signal.
[6] The image sensor according to [5], wherein the reset latch circuit (180) is configured to output a read done signal indicating that the pixel circuit (100) has detected a predefined change in illumination, and that information about the predefined change in illumination has been read out from the pixel circuit (100).
[7] The image sensor according to any of [5] and [6], wherein the reset latch circuit (180) is configured to output an autozero signal indicating start and end of a complete period of the reset ramp signal following the detection of a predefined change in illumination the pixel circuit (100).
[8] The image sensor according to any of [6] to [7], wherein each pixel circuit (100) includes a switching circuit (185) configured to disable the request signal in case the read done signal and/or the autozero signal is active.
[9] The image sensor according to [1], further including: a row arbiter circuit (30) configured to output a group select signal for a first group of the pixel circuits (100) in response to a group request signal received from any of the pixel circuits (100) of the first group.
[10] The image sensor according to [9], wherein the ramp signal circuit (20) is configured to output the reset ramp signal for the first group of the pixel circuits (100) in response to the group select signal for the first group of pixel circuits (100).
[11] The image sensor according to any of [9] and [10], wherein the pixel circuits (100) are assigned to pixel rows and pixel columns, and wherein the first group of the pixel circuits (100) are assigned to one of the pixel rows or to one of the pixel columns.
[12] The image sensor according to any of [9] to [11], wherein the reset latch circuit (180) is configured to output an autozero signal indicating that the pixel circuit (100) has detected a predefined change in illumination, information about the predefined change in illumination has been read out and initialization of the floating node (121) is not complete.
[13] The image sensor according to any of [9] to [12], wherein a trailing edge of the reset ramp signal changes at a rate at least ten times slower than a leading edge of the group select signal.
[14] The image sensor according to any of [1] to [13], wherein each pixel circuit (100) further includes a reset latch circuit (180) and an autozero enable switch (150), wherein the autozero enable switch (150) is configured to pass the reset ramp signal to the reset switch (126) in response to an autozero signal, and wherein the reset latch circuit (180) is configured to output the autozero signal in response to the predefined change in illumination.
[15] The image sensor according to [14], wherein the autozero enable switch (150) includes an NFET (151) and a PFET (152) electrically connected in parallel between an output of the ramp signal circuit (20) and a control input of the reset switch (126).

1. An image sensor, comprising:
a pixel array comprising pixel circuits, wherein each pixel circuit is configured to output a request signal in response to a predefined change in illumination, wherein each pixel circuit comprises a floating node configured to temporally store charge as a function of a change of an illumination condition, and wherein each pixel circuit comprises a reset switch configured to set the floating node to a predefined initial potential in response to a reset ramp signal; and
a ramp signal circuit configured to output the reset ramp signal for at least a first group of the pixel circuits.

2. The image sensor according to claim 1,
wherein the pixel circuits are configured such that, for each pixel circuit, the reset ramp signal is passed to the reset switch only for a period of time after detection of a predefined change in illumination in the pixel circuit and before an end of setting the initial potential of the floating node.

3. The image sensor according to claim 1,
wherein the ramp signal circuit is configured to output the reset ramp signal at regular time intervals.

4. The image sensor according to claim 1,
wherein the ramp signal circuit is configured to output the reset ramp signal for each pixel circuit of the pixel array.

5. The image sensor according to claim 3,
wherein each of the pixel circuits comprises a reset latch circuit configured to suppress an output of the request signal for a period starting after information about the predefined change in illumination has been read out until an end of a following complete period of the reset ramp signal.

6. The image sensor according to claim 5,
wherein the reset latch circuit is configured to output a read done signal indicating that the pixel circuit has detected a predefined change in illumination, and that information about the predefined change in illumination has been read out from the pixel circuit.

7. The image sensor according to claim 5,
wherein the reset latch circuit is configured to output an autozero signal indicating start and end of a complete period of the reset ramp signal following the detection of a predefined change in illumination the pixel circuit.
wherein each pixel circuit comprises a switching circuit configured to disable the request signal in case the read done signal and/or the autozero signal is active.

9. The image sensor according to claim 1, further comprising:
a row arbiter circuit configured to output a group select signal for a first group of the pixel circuits in response to a group request signal received from any of the pixel circuits of the first group.

10. The image sensor according to claim 9,
wherein the ramp signal circuit is configured to output the reset ramp signal for the first group of the pixel circuits in response to the group select signal for the first group of pixel circuits.

11. The image sensor according to claim 9,
wherein the pixel circuits are assigned to pixel rows and pixel columns, and wherein the first group of the pixel circuits are assigned to one of the pixel rows or to one of the pixel columns.

12. The image sensor according to claim 9,
wherein the reset latch circuit is configured to output an autozero signal indicating that the pixel circuit has detected a predefined change in illumination, information about the predefined change in illumination has been read out and initialization of the floating node is not complete.

13. The image sensor according to claim 9,
wherein a trailing edge of the reset ramp signal changes at a rate at least ten times slower than a leading edge of the group select signal.

14. The image sensor according to claim 1,
wherein each pixel circuit further comprises a reset latch circuit and an autozero enable switch, wherein the autozero enable switch is configured to pass the reset ramp signal to the reset switch in response to an autozero signal, and wherein the reset latch circuit is configured to output the autozero signal in response to the predefined change in illumination.

15. The image sensor according to claim 14,
wherein the autozero enable switch comprises an NFET and a PFET electrically connected in parallel between an output of the ramp signal circuit and a control input of the reset switch.
